(19) United States
(12) Patent Application Publication
(10) Pub. No.: US 2024/0356029 A1
(43) Pub. Date: Oct. 24, 2024

(54) NEGATIVE ELECTRODE ACTIVE MATERIAL LAYER

(71) Applicant: TOYOTA JIDOSHA KABUSHIKI KAISHA, Toyota-shi (JP)

(72) Inventor: Shinsuke MATSUHARA, Miyoshi-shi (JP)

(73) Assignee: TOYOTA JIDOSHA KABUSHIKI KAISHA, Toyota-shi (JP)

(21) Appl. No.: 18/594,035

(22) Filed: Mar. 4, 2024

(30) Foreign Application Priority Data
Apr. 18, 2023 (JP) 2023-067816

(51) Int. Cl. H01M 4/587; H01M 4/02

(52) U.S. Cl. CPC H01M 4/587; H01M 2004/021; H01M 2004/027

(57) ABSTRACT

The negative electrode active material layer of the present disclosure comprises a carbonaceous negative electrode active material,
wherein the negative electrode active material layer has an orientation I₀₀₄/I₁₁₀ of 1.00 or more and 2.00 or less as measured by X-ray diffractometry, and
wherein in the frequency distribution of D/G of the carbonaceous negative electrode active material, which is the ratio of the peak intensity of the D-band to the peak intensity of the G-band obtained by Raman mapping measurement, the mode value is 0.5 or more and 0.8 or less, and the half width of the peak having the mode value is 0.3 or more and 0.6 or less.

### FIELD

The present disclosure relates to a negative electrode active material layer.

### BACKGROUND

A carbon material such as graphite is generally used as a negative electrode active material of a secondary battery, particularly a lithium ion secondary battery. Among them, graphite has a structure in which hexagonal network surfaces of carbon atoms are regularly stacked. Charging and discharging are performed by the intercalation and deintercalation reaction of the lithium ions from the end portions of the stacked net surfaces. In particular, in order to confirm the performance of graphite as an active material, the ratio of the values of “G band” and “D band” is evaluated in Raman mapping. The “G band” indicates the peak intensity of the wavelength 1580 cm⁻¹, and the “D band” indicates the peak intensity of the wavelength 1360 cm⁻¹.

In Patent Literature 1, carbonaceous grains for negative electrode materials are disclosed in which the mode value of G/D is 0.87 to 0.96, and the R value is 0.88 to 0.92 when the cumulative frequency from the side having a smaller G/D is 50%.

In Patent Document 2, a negative electrode active material having a G/D ratio of 0.21 or more is described.

### CITATION LIST

### Patent Literature

[PTL 1] WO2019/159367
[PTL 2] WO2014/128814

### SUMMARY

### Technical Problem

The present disclosure provides a negative electrode active material layer having improved resistance.

### Solution to Problem

The inventors of the present disclosure have made intensive studies and have found that the above problem can be solved by the following means, and have completed the present disclosure. That is, the present disclosure is as follows:

<Aspect 1> A negative electrode active material layer comprising a carbonaceous negative electrode active material,
wherein the negative electrode active material layer has an orientation I₀₀₄/I₁₁₀ of 1.00 or more and 2.00 or less as measured by X-ray diffractometry, and
wherein in the frequency distribution of D/G of the carbonaceous negative electrode active material, which is the ratio of the peak intensity of the D band to the peak intensity of the G band, obtained by Raman mapping measurement, the mode value is 0.50 or more and 0.80 or less, and the half width of the peak having the mode value is 0.3 or more and 0.6 or less.
   <Aspect 2> The negative active material layer according to Aspect 1, wherein D50 particle size of the carbonaceous negative polarity active material measured by laser diffraction method is 17.0 μm or less.
   <Aspect 3> The negative electrode active material layer according to any one of Aspect 1 or 2, wherein the carbonaceous negative electrode active material is graphite.
   <Aspect 4> The negative electrode active material layer according to any one of Aspects 1 to 3, wherein the density thereof is 1.2 g/cc or more and 1.6 g/cc or less.
   <Aspect 5> A secondary battery comprising at least the negative electrode active material layer according to any one of Aspects 1 to 4, a separator, and a positive electrode active material layer.

### Advantageous Effects of Invention

According to the present disclosure, a negative electrode active material layer having improved resistance can be provided.

### BRIEF DESCRIPTION OF DRAWINGS

FIG. 1 It is a schematic diagram of a secondary battery of the present disclosure.

### DESCRIPTION OF EMBODIMENTS

### <<Negative Electrode Active Material Layer>>

The negative electrode active material layer of the present disclosure comprises a carbonaceous negative electrode active material,
wherein the negative electrode active material layer has an orientation I₀₀₄/I₁₁₀ of 1.00 or more and 2.00 or less as measured by X-ray diffractometry, and
wherein in the frequency distribution of D/G of the carbonaceous negative electrode active material, which is the ratio of the peak intensity of the D-band to the peak intensity of the G-band obtained by Raman mapping measurement, the mode value is 0.5 or more and 0.8 or less, and the half width of the peak having the mode value is 0.3 or more and 0.6 or less.

According to the negative electrode active material layer of the present disclosure, the negative electrode active material layer has an appropriate degree of orientation, and the reaction surface of the carbonaceous negative electrode active material optimally matches the diffusion direction of the lithium ions. In addition, the carbonaceous negative electrode active material has an appropriate D/G frequency distribution (mode value and half width), thereby providing an appropriate lithium ion intercalation site. As a result of these, it is believed that the resistance is reduced when the negative electrode active material layer used in a lithium ion battery.

The degree of orientation I₀₀₄/I₁₁₀ of the negative electrode active material layers measured by X-ray diffractometry (XRD) may be 1.00 or more, 1.10 or more, or 1.20 or more, and may be 2.00 or less, 1.90 or less, 1.80 or less, 1.70 or less, 1.60 or less, 1.50 or less, or 1.40 or less. The larger the value, the higher the orientation. By increasing the density of the negative electrode active material layer, the degree of orientation can be increased. Here, the degree of orientation means the ratio of the peak intensity I₀₀₄ of the (004) plane to the peak intensity I₁₁₀ of the (110) plane of the crystals constituting the negative electrode active material layers measured by X-ray diffractometry (XRD).

From the viewpoint of obtaining the degree of orientation, the negative electrode active material layers are preferably 1.1 g/cc or more, 1.2 g/cc or more, or 1.3 g/cc or more, and are preferably 1.7 g/cc or less, 1.6 g/cc or less, or 1.5 g/cc or less.

The negative electrode active material layer may contain other optional components. Examples of the other components include a conductive auxiliary agent and a binder.

Hereinafter, each component of the present disclosure will be described.

### <Carbons Negative Electrode Active Material>

In the carbonaceous negative electrode active material of the present disclosure, the mode value is 0.5 or more and 0.8 or less, and the half width of the peak having the mode value is 0.3 or more and 0.6 or less in the frequency distribution of D/G of the carbonaceous negative electrode active material, which is the ratio of the peak intensity of the D band to the peak intensity of the G band, obtained by Raman mapping measurement.

Here, in the present specification, the “D band” indicates the peak intensity of the wavelength 1360 cm⁻¹, and the “G band” indicates the peak intensity of the wavelength 1580 cm⁻¹.

The Raman mapping can be measured under the following conditions.
Magnification of the objective lens: 50 times
Exposure time: 2 seconds
Total number of times: 4
Sampling range: 100 μm×100 μm
Measuring interval: 2 μm

The mode value of D/G may be 0.50 or more, 0.55 or more, 0.60 or 0.65 or more, or 0.70 or more, or 0.80 or less, or 0.75 or less. When the crystallinity of the carbonaceous negative electrode active material is increased, the mode value of D/G is reduced. The crystallinity of the carbonaceous negative electrode active material can be increased by grinding the carbonaceous negative electrode active material, that is, by reducing the particle diameter or by coating the carbonaceous negative electrode active material, whereby the mode value of D/G can be reduced.

This mode value, in terms of G/D, is 2.00 or less, 1.82 or less, 1.67 or less, 1.54 or less, or 1.43 or less, and corresponds to 1.25 or more, or 1.33 or more.

The above half width may be more than 0.30, 0.35 or more, 0.40 or more, or more than 0.45, and may be not more than 0.60, not more than 0.55, or not more than 0.50.

In the Raman mapping of the carbonaceous negative electrode active material of the present disclosure, the regions A in which D/G is 0.5 or more and 0.8 or less can be uniformly distributed. In addition, when there is a region B whose D/G is outside the range, the positional relationship between the region A and the region B may be a positional relationship such as a sea-island structure in which the region A is a sea and the region B is an island.

As the carbonaceous negative electrode active material having the above-described frequency distribution characteristics, various materials having a potential at which ions are occluded and released (charge and discharge potential) which is a lower potential than that of the above-described positive electrode active material can be used. For example, a carbon-based active material such as graphite, graphite, or hard carbon can be used. Only one type of the carbonaceous negative electrode active material may be used alone, or two or more types may be used in combination.

In particular, when the carbonaceous negative electrode active material is graphite, D50 grain size of the graphite may be 20.0 μm or less, 18.0 μm or less, 17.0 μm or less, 16.5 μm or less, 16.0 μm or less, or 15.7 μm or less, and may be 5.0 μm or more, 6.0 μm or more, 7.0 μm or more, 8.0 μm or more, 9.0 μm or more, 10.0 μm or more, 11.0 μm or more, 12.0 μm or more, 13.0 μm or more, or 14.0 μm or more. Here, D50 particle diameter means a median diameter (D50) calculated on a volume basis by a laser diffractometry method.

### <Binder>

As the binder optionally contained in the negative electrode active material layer, a binder known as a binder used in a secondary battery may be used. For example, a styrene butadiene rubber (SBR)-based binder, a carboxymethyl cellulose (CMC)-based binder, an acrylonitrile butadiene rubber (ABR)-based binder, a butadiene rubber (BR)-based binder, a polyvinylidene fluoride (PVDF)-based binder, a polytetrafluoroethylene (PTFE)-based binder, and the like may be used. Only one binder may be used alone, or a combination of two or more binders may be used. The amount of the binder contained in the negative electrode active material layer is not particularly limited.

### <Conductive Auxiliary Agent>

As the conductive auxiliary agent optionally contained in the negative electrode active material layer, one well known as a conductive auxiliary agent used in a secondary battery may be used. Specifically, a carbon material such as Ketjen Black (KB), a vapor-phase carbon fiber (VGCF), acetylene black (AB), carbon nanotubes (CNT), carbon nanofibers (CNF), carbon black, coke, graphite, or the like may be used. Alternatively, a metal material capable of withstanding the environment when the battery is used may also be used. As the conductive auxiliary agent, only one kind may be used alone, or a combination of two or more kinds may be used. The shape of the conductive auxiliary agent may be various shapes such as powdery, fibrous, and the like. The amount of the conductive auxiliary agent contained in the negative electrode active material layer is not particularly limited.

### <<Secondary Battery>>

The secondary battery of the present disclosure includes at least the negative electrode active material layer, the separator, and the positive electrode active material layer.

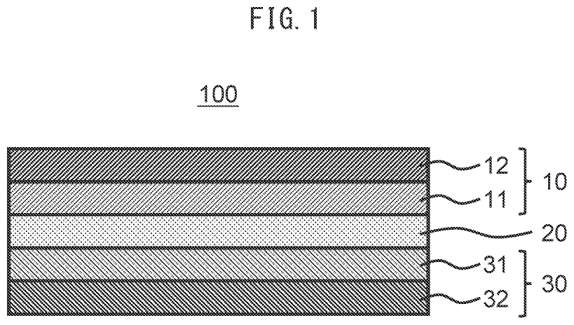

FIG. 1 schematically illustrates a configuration of a secondary battery 100 according to a first embodiment of the present disclosure. As illustrated in FIG. 1, the secondary battery 100 may include a positive electrode 10, a separator 20, and a negative electrode 30. The positive electrode 10 may include the positive electrode active material layer 11 and the positive electrode current collector layer 12, and the negative electrode 30 may include the negative electrode active material layer 31 and the negative electrode current collector layer 32. In this case, the positive electrode active material layer 11 may include the above-described positive electrode active material. The electrolyte may be included in the positive electrode active material layer 11 and the negative electrode active material layer 31, for example, in the form of an electrolytic solution, although not shown.

### <Negative Electrode Current Collector Layer>

The negative electrode current collector layer may be formed of a known metal or the like that can be used as a negative electrode current collector of a secondary battery. Such a metal may be, for example, a metal material containing at least one element selected from the group consisting of Cu, Ni, Al, V, and Au, Pt, Mg, Fe, Ti, Pb, Co, Cr, Zn, Ge, In, Sn, Zr. The form of the negative electrode current collector layer is not particularly limited, and may be various forms such as a foil form, a mesh form, and a porous form. The negative electrode current collector layer may be formed by plating or depositing the metal on the surface of a substrate made of an optional material. The surface of the negative electrode current collector layer may be coated with a carbon material or the like.

### <Separator>

As the separator, a separator well known as a separator used in a secondary battery may be used. For example, the separator may be made of a resin such as polyethylene (PE), polypropylene (PP), polyester, and polyamide. The separator may have a single-layer structure or a multi-layer structure. As the separator having a multilayer structure, for example, a separator having a multilayer structure composed of the above resin, for example, a separator having a PE/PP two-layer structure, a separator having a PP/PE/PP or PE/PP/PE three-layer structure, or the like can be used. The separator may be composed of a nonwoven fabric such as a cellulose nonwoven fabric, a resin nonwoven fabric, or a glass fiber nonwoven fabric. The thickness of the separator is not particularly limited, and may be, for example, 5 μm or more and 1 mm or less.

### <Positive Electrode Active Material Layer>

The positive electrode active material layer contains a positive electrode active material. In addition, the positive electrode active material layer may contain an optional other component. Examples of the other components include a conductive auxiliary agent and a binder.

### (Positive Electrode Active Material)

As the positive electrode active material, an optional positive electrode active material can be used depending on the form of the secondary battery, and is not particularly limited. For example, in the case where the secondary battery is a lithium ion secondary battery, for example, a lithium-containing oxide can be used as the positive electrode active material.

The lithium-containing oxide as the positive electrode active material is not particularly limited, and may include, for example, at least Li, at least one transition-metal element selected from Co, Ni and Mn, and O. As such a lithium-containing oxide, lithium cobaltate (LiCoO₂), lithium nickelate (LiNiO₂), lithium manganate (LiMn₂O₄), or a nickel-cobalt-manganese-based oxide (NCM) in which some of these elements are replaced with other elements can be used. NCM is generally represented by the general formula of LiₐMnₓNi_{y}Co_{z}O_{2±δ} (0<a≤1.5, 0≤x≤1.5, 0≤y≤1.5, 0≤z≤1.5, 0<δ (=x+y+z)<1.5). The lithium-containing oxide as the positive electrode active material may have, for example, a O₂ type structure, a O₃ type structure, or a crystalline structure other than these. As the positive electrode active material, only one kind may be used alone, or two or more kinds may be used in combination.

### <Positive Electrode Current Collector Layer>

The positive electrode current collector layer may be formed of a known metal or the like that can be used as a positive electrode current collector of a secondary battery. Such a metal may be a metal comprising at least one element selected from the group consisting of Cu, Ni, Al, V, Au, Pt, Mg, Fe, Ti, Pb, Co, Cr, Zn, Ge, In, Sn, Zr. The form of the positive electrode current collector layer is not particularly limited, and may be various forms such as a foil form, a mesh form, and a porous form. The negative electrode current collector layer may be formed by plating or depositing the metal on the surface of a substrate made of an optional material.

### <Electrolyte>

The electrolyte solution contains a solvent and an electrolyte. The electrolytic solution may contain an alkali metal ion as a carrier ion, for example, a lithium ion.

### (Solvent)

As the solvent, water and an organic solvent can be used.

As the organic solvent, for example, a carbonate-based solvent such as ethylene carbonate (EC), dimethyl carbonate (DMC), ethyl methyl carbonate (EMC), or fluoroethylene carbonate (FEC) can be used. These organic solvents may be used singly or in combination.

### (Electrolyte)

The electrolyte is selected according to the form of the secondary battery. For example, when the secondary battery is a lithium ion secondary battery, it may be, for example, a lithium salt. For example, LiPF₆ or the like can be used as the lithium-salt.

### EXAMPLES

The present disclosure will be described in detail with reference to Examples and Comparative Examples, but the present disclosure is not limited thereto.

### <Production of Secondary Battery>

### Example 1

92 parts by mass of LiNiCoMnO₂ as a positive electrode active material, 5 parts by mass of acetylene black as a conductive auxiliary agent, and 3 parts by mass of polyvinylidene fluoride as a binder were mixed to prepare a slurry for the positive electrode active material layers.

Next, the obtained slurry for the positive electrode active material layer was applied to a Al foil having a thickness of 15 micrometers as a positive electrode current collector layer, and pressed to a predetermined thickness to obtain a positive electrode.

98 parts by mass of graphite (carbonaceous negative electrode active material C, D50 particle size 16.5 μm) as a carbonaceous negative electrode active material, and 1 part by mass of carboxymethyl cellulose and 1 part by mass of styrene butadiene rubber as a binder were mixed to prepare a slurry for the negative electrode active material layers.

Next, the obtained negative electrode active material layer slurry was applied to a Cu foil having a thickness of 10 μm as the negative electrode current collector layer, and the applied slurry for the negative electrode active material layer was pressed so that the negative electrode active material layer had a 1.4 g/cc density, thereby obtaining a negative electrode.

The orientation degree I₀₀₄/I₁₁₀ of the obtained negative electrode active material layers was measured by X-ray diffractometry.

The obtained positive electrode and negative electrode were wound through a polypropylene/polyethylene/polypropylene trilayer sheet having a thickness of 24 μm as a separator to prepare an electrode group.

A current collector plate with a lid was welded to both ends of the electrode group, and this was inserted into the case, and the lid plate and the case were welded. Next, a predetermined amount of the electrolytic solution was injected from the injection hole, a sealing screw was tightened to the injection hole, and after the injection, the electrolytic solution was allowed to stand for an appropriate time to impregnate, and after charging, aging was performed at 60° C., thereby obtaining a secondary battery of Example 1. As the solvent of the electrolytic solution, 3 parts by mass of ethylene carbonate, 3 parts by mass of dimethyl carbonate, and 4 parts by mass of ethyl methyl carbonate were used. As electrolyte, LiPF₆ was used at 1 mol/L levels.

In addition, the Raman mapping of the carbonaceous negative electrode active material used was measured under the following conditions, thereby obtaining the mode value of D/G and the half-width of the peak having the mode value mode.
Magnification of the objective lens: 50 times
Exposure time: 2 seconds
Total number of times: 4
Sampling range: 100 μm×100 μm
Measuring interval: 2 μm

### Examples 2 to 6 and Comparative Examples 1 to 7

The secondary batteries of Examples 2 to 6 and Comparative Examples 1 to 7 were prepared in the same manner as in Example 1, except that the carbonaceous negative electrode active material of the type shown in Table 1 was used as the carbonaceous negative electrode active material and the density of the negative electrode active material layer was adjusted as shown in Table 1.

Details of the carbonaceous negative electrode active material shown in Table 1 are as follows.
Carbons negative electrode active material A: graphite having an D50 particle diameter of 15.5 μm
Carbons negative electrode active material B: graphite having an D50 particle diameter of 15.8 μm
Carbons negative electrode active material D: graphite having an D50 particle diameter of 14.7 μm
Carbons negative electrode active material: graphite having an D50 particle size of 15.5 μm
Carbons negative electrode active material F: graphite having an D50 particle diameter of 15.6 μm
Carbons negative electrode active material G: graphite having an D50 particle diameter of 16.9 μm
Carbons negative electrode active material H: graphite having an D50 particle diameter of 16.7 μm
Carbons negative electrode active material I: graphite having an D50 particle diameter of 15.8 μm

### <<Measurement of Resistance>>

In a controlled atmosphere at −10° C., from the state of SOC60%, 2 C was energized for 10 minutes. The resistance was measured from the difference between the voltage after charging and the voltage before charging and the current value.

The configurations and evaluation results of the examples and comparative examples are shown in Table 1.

### [Table 1]

TABLE 1

| | Carbons negative | | | Negative electrode | | |
|---|---|---|---|---|---|---|
| | electrode active material | | | active material layer | | |
| | | Raman | | | Degree of | |
| | | mapping | | Electrode | orienta- | Resis- |
| | | | Half | density | tion | tance |
| | Type | D/G | width | (g/cc) | I004/I110 | (Ω) |
| Comparative | A | 0.20 | 0.12 | 1.4 | 4.32 | 100 |
| Example 1 | | | | | | |
| Comparative | B | 0.32 | 0.32 | 1.4 | 2.31 | 102 |
| Example 2 | | | | | | |
| Example 1 | C | 0.54 | 0.34 | 1.4 | 1.05 | 93 |
| Example 2 | D | 0.58 | 0.47 | 1.4 | 1.85 | 94 |
| Example 3 | E | 0.63 | 0.51 | 1.4 | 1.37 | 95 |
| Example 4 | F | 0.72 | 0.45 | 1.4 | 1.23 | 95 |
| Example 5 | F | 0.72 | 0.45 | 1.2 | 1.01 | 93 |
| Example 6 | F | 0.72 | 0.45 | 1.6 | 1.95 | 97 |
| Comparative | G | 0.81 | 0.11 | 1.4 | 1.23 | 104 |
| Example 3 | | | | | | |
| Comparative | G | 0.81 | 0.11 | 1.2 | 1.12 | 104 |
| Example 4 | | | | | | |
| Comparative | G | 0.81 | 0.11 | 1.6 | 2.18 | 107 |
| Example 5 | | | | | | |
| Comparative | H | 1.03 | 0.43 | 1.4 | 2.35 | 110 |
| Example 6 | | | | | | |
| Comparative | I | 0.62 | 0.24 | 1.4 | 1.85 | 101 |
| Example 7 | | | | | | |

From Table 1, it can be understood that the secondary battery having the negative electrode active material layer of the Examples can realize low resistance, in the Examples, the orientation degree I₀₀₄/I₁₁₀ is 1.00 or more and 2.00 or less, and. in the frequency distribution of DIG of the carbonaceous negative electrode active material obtained by Raman mapping measurement, which is the ratio of the peak intensity of the D band to the peak intensity of the G band, the mode is 0.50 or more and 0.80 or less, and the half width of the peak having the mode is 0.3 or more and 0.6 or less.

Further, although not illustrated, in the Raman mapping of the carbonaceous negative electrode active material of Example 3, the positional relationship between the region A in which the value of D/G is 0.5 or more and 0.8 or less is uniformly distributed, and the region B in which the value of D/G is outside this range, the region A is the sea, the region B is the sea-island structure like the island.

### REFERENCE SIGNS LIST

10 Positive electrode
11 Positive electrode active material layer
12 Cathode current collector
20 Separator
30 Negative electrode
31 Negative electrode active material layer
32 Anode current collector
100 Secondary battery

1. A negative electrode active material layer comprising a carbonaceous negative electrode active material,
wherein the negative electrode active material layer has an orientation I₀₀₄/I₁₁₀ of 1.00 or more and 2.00 or less as measured by X-ray diffractometry, and
wherein in the frequency distribution of D/G of the carbonaceous negative electrode active material, which is the ratio of the peak intensity of the D band to the peak intensity of the G band, obtained by Raman mapping measurement, the mode value is 0.50 or more and 0.80 or less, and the half width of the peak having the mode value is 0.3 or more and 0.6 or less.

2. The negative active material layer according to claim 1, wherein D50 particle size of the carbonaceous negative polarity active material measured by laser diffraction method is 17.0 μm or less.

3. The negative electrode active material layer according to claim 1, wherein the carbonaceous negative electrode active material is graphite.

4. The negative electrode active material layer according to claim 1, wherein the density thereof is 1.2 g/cc or more and 1.6 g/cc or less.

5. A secondary battery comprising at least the negative electrode active material layer according to claim 1, a separator, and a positive electrode active material layer.
